(19) United States
(12) Patent Application Publication
(10) Pub. No.: US 2008/0222026 A1
(43) Pub. Date: Sep. 11, 2008

(54) Derivatives for multi region properties

(76) Inventor: Bidyut Niyogi, Millburn, NJ (US)

Correspondence Address: Bidyut K. Niyogi, 78 Cypress Street, Millburn, NJ, 07041, US

(21) Appl. No.: 11/895,062

(22) Filed: Aug. 24, 2007

Related U.S. Application Data
(60) Provisional application No. 60/905,167, filed on Mar. 6, 2007.

(51) Int. Cl. G06Q 40/00

(52) U.S. Cl. 705/38

(57) ABSTRACT

The present invention relates to a multiple step business process for innovative risk of credit derivatives in computer aligned and mathematical models for management of credit derivatives through the use of different financial platforms and multiple hybrid financial instruments of currency funds for capital flow for property acquisitions, in which the source of each aspect of hybrid financial instruments will be provided with predetermined risk values and risk management for specified periods of time linked to the life span of a property or capital for property acquisition, an improvement in the different hybrid forms of financial instruments include varied debt obligation financial instruments together with different forms of currency, equity holdings, gold, and alternative property.

### CROSS-REFERENCE TO RELATED APPLICATION

The present application claims the benefit of previously filed co-pending Provisional Patent Application, Ser. No. 60/905,167, filed on 03/06/2007.

### FIELD OF THE INVENTION

The present invention relates to a multiple step business process for an innovation in risk management of all types of credit derivatives including synthetic derivatives and cov-lite instruments through the use of different financial platforms and hybrid derivates and financial instruments of funds of different currencies tied to different countries for capital flow and for financing for property acquisition in different geographical regions, for essentially fixed and non movable properties., as well as movable properties.

### BRIEF SUMMARY OF THE INVENTION

It is generally known to use cash bond markets and credit derivatives for property acquisitions. However, the present invention utilizes hybrid credit risk financial instruments and also synthetic credit derivatives for at least multi-regions in different geographical locations as well as multi-type property acquisitions. Moreover, the invention uses mathematical models for evaluation of the properties, so that over valued and under valued properties can be correlated to the market conditions so as to exploit the valuation difference.

It should be appreciated that a holding entity many only have shopping malls, may plan to expand into other forms of more profitable properties, such as hotels, casinos, golf courses, luxury cruise liners, commercial office spaces, amusement parks or the likes. The mathematical models would assign specific values to different properties.

The present invention includes a multiple step business process for innovative risk management of credit derivatives through the use of different financial platforms and multiple hybrid financial instruments of different currency funds for capital flow for property acquisition, with the use of mathematical models in which the source of each aspect of hybrid financial instruments will be provided with predetermined risk values and risk management in varied financial layers for specified periods of time linked to the life span of at least a property or capital for a property acquisition, characterized in that an improvement in the different hybrid forms of financial instruments includes varied debt obligation financial instruments together with different forms of currency, equity holdings, gold, and alternative property in a different geographical region.

Is should be noted that a combination of varied arranged forms of financial blended or hybrid derivatives in the financial platforms such as collateralised debt obligation instruments, that generally known in the financial markets as CDO's provide the financial platforms that gather together different and varied from of debt assets which are then bundled together with different risk values are placed and sold in tranches in the capital markets. The CDO's may also include different forms of tradable currencies or tradable financial instruments, such as US Treasury bonds, UK gilts or the like. The tranches have different debt values and risk factors and traded in different capital markets.

Conveniently, the invention has with each financial platform at least varied debt obligation instruments, linked to at least a property and corresponding risk management and credit derivatives.

Advantageously, a risk management fee should be imposed on an annual basis or a lump sum be payable at predetermined intervals. For example, the fixed risk fee on annual basis would be established at ten or fifteen or twenty basis points of the total transaction of the credit risk. Thus, for a credit risk on an annual basis, for a billion dollars the total fee would amount to a million dollars.

Suitably, the invention is characterized by the credit risk to be managed for a specified financial platform and linked derivatives may be for a specified property or group of properties, for a predetermined time interval, for a particular country and assigned to the related financial platform and corresponding risk derivatives and the currency in which it is to be executed.

The invention furthermore includes a multiple step business process for innovative risk management of credit derivatives of different financial platforms of at least different capital and hybrid debt obligation, characterized in that the improvement of the inventive product being directly linked to varying forms of currency, along with at least a property or properties in different geographical regions, and the financial risk management that follows with it. It should be noted that a defined geographical region could be in a single country or in different countries constituting a hybrid property derivative contract. Such a hybrid situation could be based with shopping malls in the USA, the hotels in Australia and the casinos in the south of France. The corresponding risk fees could be in US dollars or in an established currency.

It should appear feasible that the hybrid derivates could cover risk-managed debts in different geographical regions of the world, with different currencies.

Advantageously, the business process for innovative risk management through credit derivatives will be characterized by the credit risk derivative management would correspondingly adjust for the geographical market and also adjust with the group of properties acquired with hybrid currencies and varied debt obligation instruments originating in different currencies and geographical locations.

Moreover, the process also incorporate multiple steps characterized by the credit risk to be managed by the financial platform of an institution, may be linked to a specified form of hybrid derivative obligations, including different currencies associated with properties to be acquired in different geographical locations, with varied property life spans.

It should be noted also that loan only Credit Derivatives may also be used for market participants for property derivative contracts.

It is also an invention business process, suitably characterized by the hybrid credit risk derivatives to be managed by a financial institution, for at least a specific property or group of properties, for a predetermined time, for at least a specific property in a particular country or geographical region.

Accordingly, such credit derivatives make property dealers take steps to make credit risks easy between different capital markets with varied forms of currencies, and swaps of different scale and type of properties in a global environment.

Finally, most of these properties are at a fixed location, except for works of arts, gold bars or the like, horse breeding rights where the credit risk are movable to different regions. This also applies to other movable properties such as railways rolling stock, marine vessels like cruise ships and passenger ships, or merchant vessels including oil tankers. Aircrafts of all kinds that are subject to financing and leasing are also a part of the credit risk derivatives contract.

What I claim is:

1. A multiple step business process for innovation risk of credit derivatives in computer aligned management of credit derivatives through the use of different financial platforms and multiple hybrid financial instruments of different currency funds for capital flow for property acquisition, including the use of mathematical models for valuation in which the source of each aspect of hybrid financial instruments will be provided with predetermined risk values and risk management for specified periods of time linked to the life span of at least a property or capital for a property acquisition, characterized in that an improvement in the different hybrid forms of financial instruments includes varied debt obligation financial instruments together with different forms of currency, equity holdings, gold, and alternative property, managed by mathematical models.

2. A multiple step business process as claimed in claim 1 characterized by each financial platform including at least varied debt obligation instruments, linked to at least a property and corresponding risk management and credit derivatives.

3. A multiple step business process as claimed in claim 1, characterized by, the credit risk to the managed for a specified financial platform and linked derivatives may be for a specified property or group of properties, for a predetermined time, for a particular country and assigned to the related financial platform and corresponding risk derivatives.

4. A multi-step business process, for innovative risk management of credit derivatives of different financial platforms of at least different capital and hybrid debt obligation, characterized in that the improvement of the inventive product being directly linked to varying forms of currency, along with at least a property or properties in different geographical regions, and the financial risk management being coordinated by collateralized debt obligations including hybrid derivatives and managed by different mathematical models.

5. A multi-step business process for, innovative risk management through credit derivatives as claimed in claim 1, characterized by the credit risk derivative management would correspondingly adjust using mathematical models for the geographical market and also adjust with the group of properties acquired with hybrid currencies and varied debt obligation instruments originating in different currencies and geographical locations.

6. A multiple step business process for innovative risk management of hybrid credit derivatives, as claimed in claim 4, characterized by the credit risk to be managed by the financial platform by an institution, may be linked to a specified form of hybrid derivative obligations, including different currencies associated with properties to be acquired in different geographical locations, with varied property life spans.

7. A multiple step business process as claimed in claim 4, characterized by the hybrid credit risk derivatives to be managed by a financial institution, for at least a specific property or group of properties, for a predetermined time, for at least a specific property in a particular country or geographical region.

8. A multiple step business process as claimed in claim 1, characterized by the properties being fixed in any geographical location.

9. A multiple step business process as claimed in claim 1, characterized by the properties being movable to any geographical location.
